(19) United States
(12) Patent Application Publication
(10) Pub. No.: US 2015/0134941 A1
(43) Pub. Date: May 14, 2015

(54) CONTROL CENTER DEPLOYMENT METHOD FOR CLOUD-BASED SYSTEM

(71) Applicant: Institute For Information Industry, Taipei (TW)

(72) Inventors: Chung-Ting KAO, Taipei City (TW); Feng-Sheng WANG, Tainan City (TW)

(73) Assignee: Institute For Information Industry, Taipei (TW)

(21) Appl. No.: 14/079,404

(22) Filed: Nov. 13, 2013

(51) Int. Cl. G06F 9/44

(52) U.S. Cl. CPC G06F 9/4406
USPC 713/2

(57) ABSTRACT

A control center deployment method for a cloud-based system is provided. The cloud-based system includes a first appliance. The control center deployment method is applied to the first appliance and includes the following steps: (a) storing an image file corresponding to a virtual machine combined with a first control center and installing an operating system simultaneously; (b) defining a management network port connected with the management LAN for the first control center during installing the operating system; and (c) creating a virtual switch to connect the first control center with the management network port upon installing the operating system so that the first control center controls the cloud-based system through the virtual switch, the management network port and the management LAN.

### FIELD

The present invention relates to a control center deployment method. More particularly, the present invention relates to a control center deployment method for a cloud-based system.

### BACKGROUND

Cloud computing enables convenient, on-demand network access to a shared pool of configurable computing resources, for example, networks, servers, storage, applications, and services that can be rapidly provisioned and released with minimal human managerial effort or service provider interaction. For a user that is attached to the shared pool of configurable computing resources that comprise a cloud, cloud computing provides computation, applications, data access, and storage services for the user. The feature is that the user does not require knowledge of the physical location and configuration of the system that delivers the services.

Clouds have been developed as stand-alone platforms and include hardware and applications necessary to perform required services for modern people. In generally, a cloud-based system may include multiple appliances each of which may deploy a set of hosted resources such as processors, operating systems, software and other components that can be combined or strung together to form virtual machines. A user can request a virtual machine or set of machines from those resources on one or more appliances through a control center to perform intended tasks or applications. Furthermore, the user controls the appliances with their virtual machines through the control center.

Currently, there are two general way to deploy the so-called “control center.” The first one is to deploy the control center into an additional dedicated appliance which is independent from the appliances originally deployed in a cloud-based system. The second way is to deploy the control center into a virtual machine created in one of the appliances originally deployed in a cloud-based system. Meanwhile, the second way also needs an additional dedicated appliance to instruct the control center deployed into the virtual machine to control the other appliances. Obviously, both of them need additional cost for the additional dedicated appliance in conventional cloud-based systems.

In view of this, it is important to provide a more beneficial control center deployment method in conventional cloud-based systems.

### SUMMARY

An objective of certain embodiments of the present invention is to provide a more beneficial control center deployment method in conventional cloud-based systems.

To achieve the aforesaid objective, certain embodiments of the present invention provide a control center deployment method for a cloud-based system. The cloud-based system comprises a first appliance. The control center deployment method is applied to the first appliance and comprises the following steps:
(a) storing an image file corresponding to a virtual machine combined with a first control center and installing an operating system simultaneously;
(b) defining a management network port connected with the management LAN for the first control center during installing the operating system; and
(c) creating a virtual switch to connect the first control center with the management network port upon installing the operating system so that the first control center controls the cloud-based system through the virtual switch, the management network port and the management LAN.

Unlike conventional cloud-based systems, the control center can be deployed into a virtual machine created in one of the appliances of the could-based system and directly controls all the appliances of the could-based system without an additional dedicated appliance. Consequently, the present invention provides a more beneficial control center deployment method in conventional cloud-based systems.

The detailed technology and preferred embodiments implemented for the present invention are described in the following paragraphs accompanying the appended drawings for persons skilled in the art to well appreciate the features of the claimed invention.

### BRIEF DESCRIPTION OF THE DRAWINGS

FIG. 1 is a diagram of a control center deployment method for a cloud-based system according to an embodiment of the present invention;

FIG. 2A is a schematic view illustrating an example of the cloud-based system;

FIG. 2B is a diagram illustrating an example of the control center deployment method;

FIG. 3A is a schematic view illustrating another example of the cloud-based system; and

FIG. 3B is a diagram illustrating another example of the control center deployment method.

### DETAILED DESCRIPTION

The present invention may be explained with reference to the following embodiments.

However, these embodiments are not intended to limit the present invention to any specific environments, applications or implementations described in these embodiments. Therefore, the description of these embodiments is only for the purpose of illustration rather than to limit the present invention. In the following embodiments and the attached drawings, elements not directly related to the present invention are omitted from depiction. In addition, the dimensional relationships among individual elements in the attached drawings are illustrated only for ease of understanding, but not to limit the actual scale.

An embodiment of the present invention is a control center deployment method for a cloud-based system. The cloud-based system may be anyone of the well-known cloud-based systems and it may comprise one first appliance. Alternatively, the cloud-based system may further comprise at least one second appliance in addition to the first appliance. In the later case, the first appliance may be anyone of the appliances of the cloud-based system, while the at least one second appliance indicates one or all of the remaining appliances of the cloud-based system.

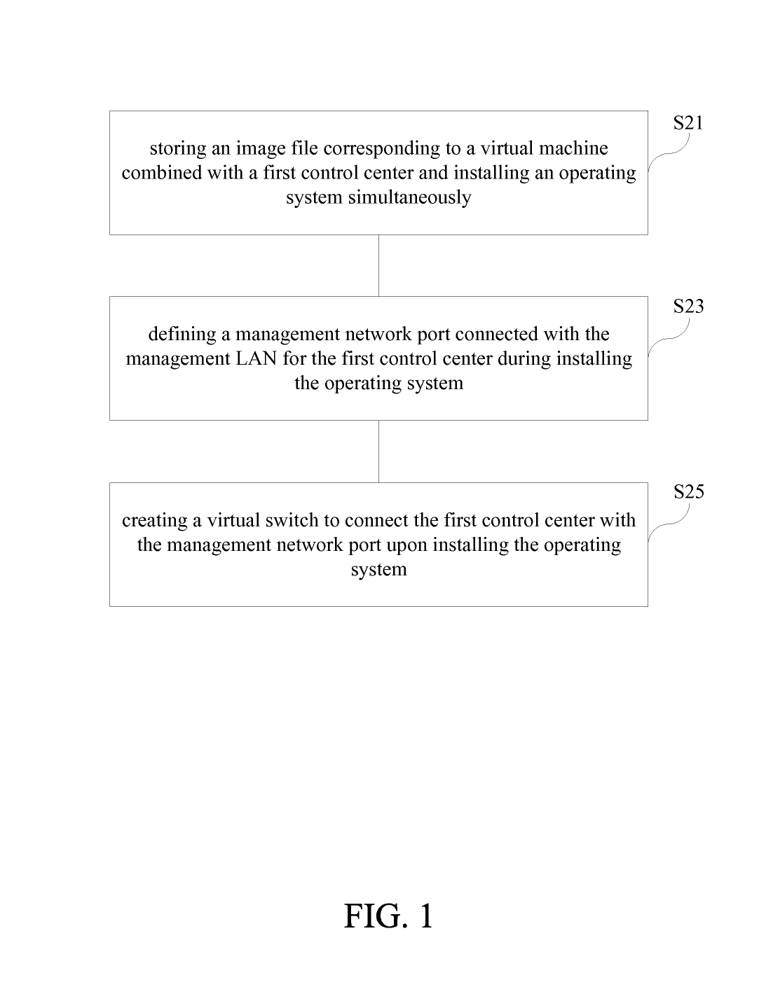

FIG. 1 is a diagram of the control center deployment method. As shown in FIG. 1, the control center deployment method is applied to the first appliance to execute steps S21, S23 and S25. Step S21 is executed to store an image file corresponding to a virtual machine combined with a first control center and install an operating system simultaneously, Step S23 is executed to define a management network port connected with the management LAN for the first control center during installing the operating system, and Step S25 is executed to create a virtual switch to connect the first control center with the management network port upon installing the operating system so that the first control center controls the cloud-based system through the virtual switch, the management network port and the management LAN.

In another embodiment where the cloud-based system may comprises a first appliance and at least one second appliance, and the at least one second appliance and the first appliance are connected via the management local area network LAN. If one second control center has been deployed in the at least one second appliance before the first control center is deployed in the first appliance, the control center deployment method may optionally comprise a step of grouping the first control center with the second control center so that the first control center and the second control center jointly control the cloud-based system.

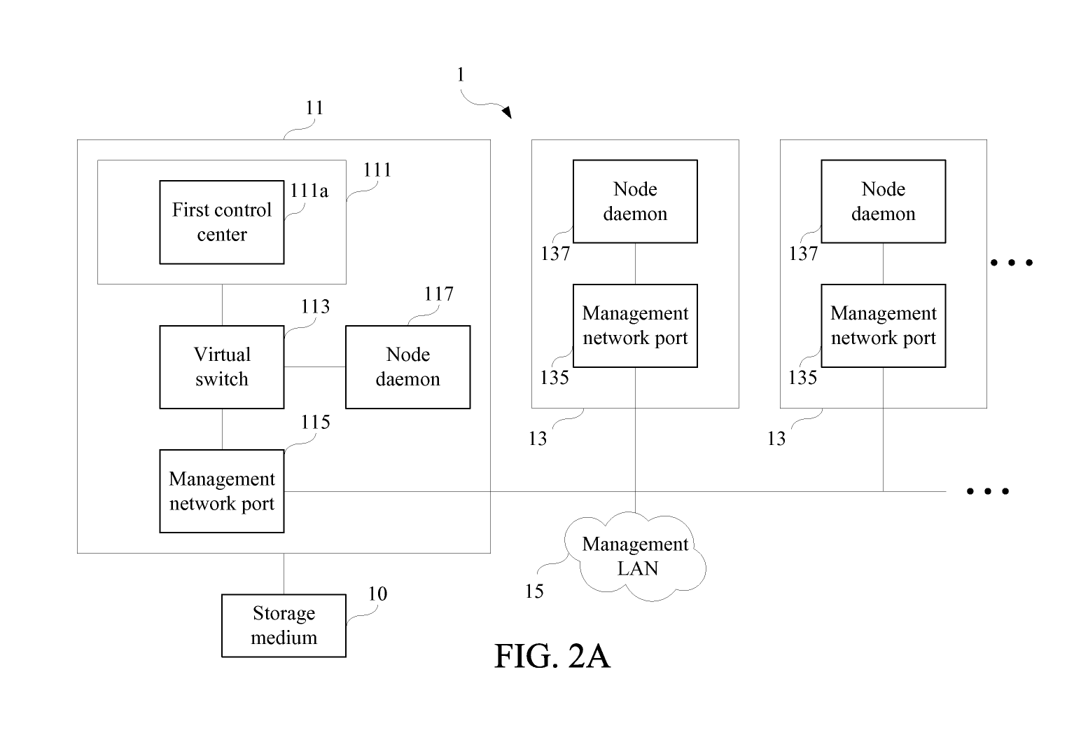

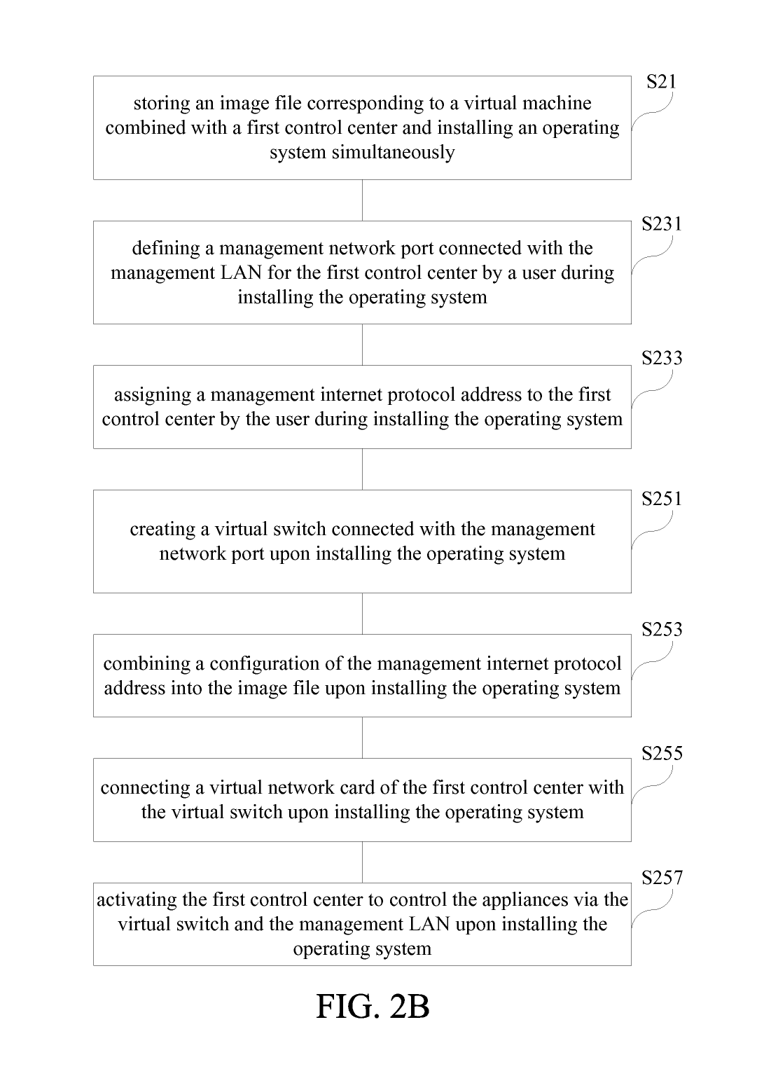

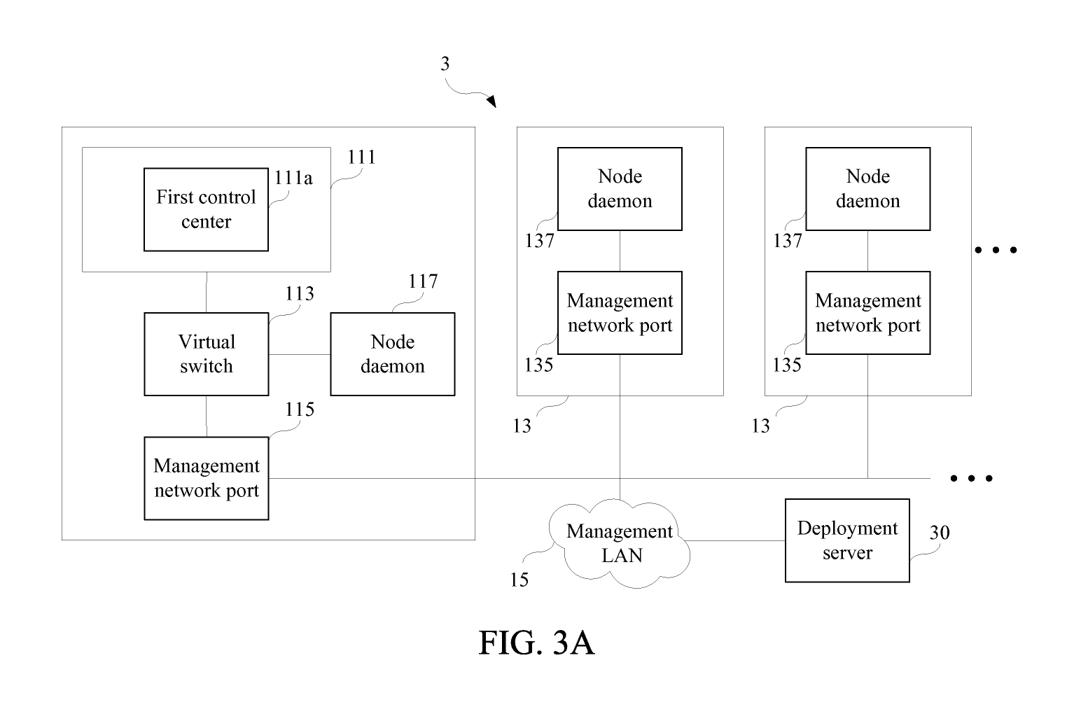

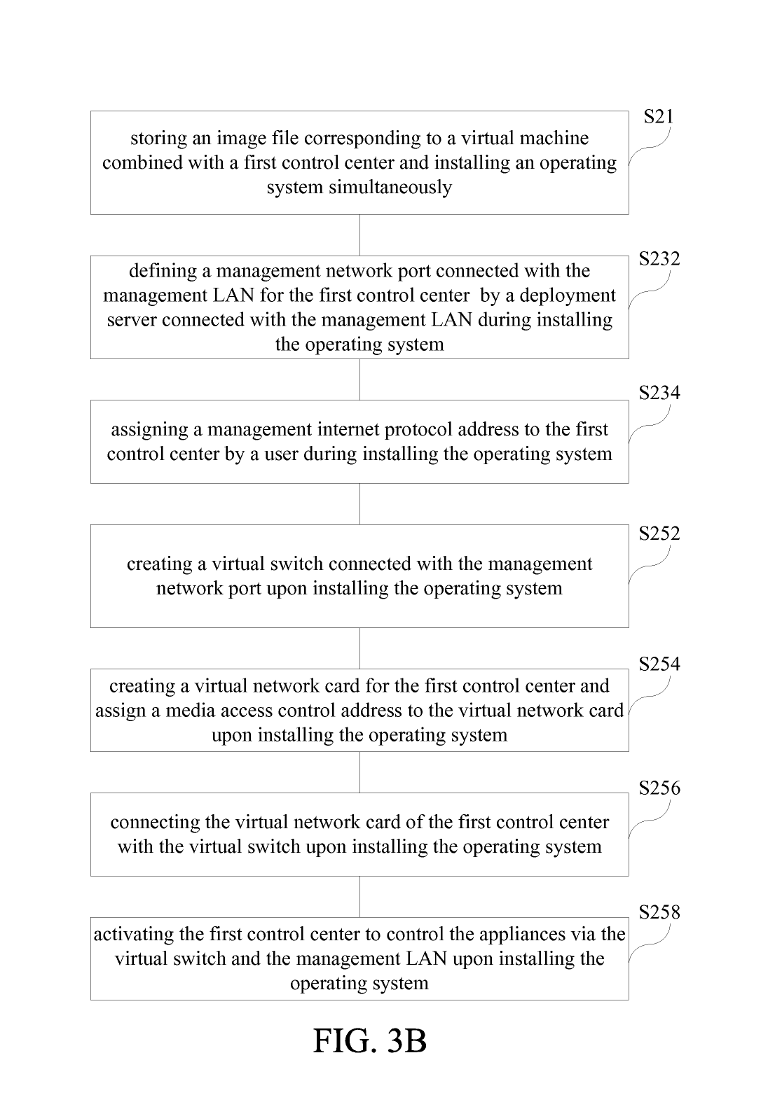

To further explain this embodiment, two examples of the control center deployment method are introduced. FIG. 2A is a schematic view illustrating the cloud-based system for the first example, while FIG. 2B is a diagram illustrating the control center deployment method for the first example. In addition, FIG. 3A is a schematic view illustrating the cloud-based system for the second example, while FIG. 3B is a diagram illustrating the control center deployment method for the second example.

As shown in FIG. 2A, a cloud-based system 1 comprising a plurality of appliances is presented. The appliances may comprise a first appliance 11 and at least one second appliance 13. However, the cloud-based system 1 may merely comprise the first appliance 11, and the control center deployment method of the present invention can still be implemented. The first appliance 11 comprises a node daemon 117 providing various cloud-based services, while each second appliance 13 comprises a node daemon 137 providing various cloud-based services and a management network port 135 connecting with a management LAN 15. In the first example, the control center deployment method is applied to the first appliance 11 in a case where the operating system is installed through a non-network installation method.

The non-network installation method means that the operating system is installed without the help of networks. Specifically, a storage medium 10 storing the operating system may be used for the installation. The storage medium 10 may be a memory, a floppy disk, a hard disk, a compact disk (CD), a mobile disk or any other storage with the same function and well known to persons of ordinary skill in the art. The method in which the operating system is installed through the storage medium 10 can be readily appreciated by persons skilled in the art, and thus it will not further be described herein.

As shown in FIG. 2B, the control center deployment method is applied to the first appliance 11 to execute steps S21, S231, S233, S251, S253, S255 and S257. As mentioned before, Step S21 is executed to store an image file corresponding to a virtual machine 111 combined with a first control center 111a and installing an operating system simultaneously. The operating system may be referred to as a hypervisor, which might be VMware vSphere, Microsoft Hyper-V, Citrix XenServer, or the like. The node daemon 117 may be created according to the operating system. The image file is configured to deploy the first control center 111a into the virtual machine 111 to create a virtual control center in the first appliance 11.

In the first example, step S23 may further comprises steps S231 and S233. Step S231 is executed to define a management network port 115 connected with the management LAN 15 for the first control center 111a by a user during installing the operating system. The user can choose any network port connected with the management LAN 15 to be the management network port 115 so that the first appliance 11 and all the second appliances 13 can be connected in the management LAN 15.

Step S233 is executed to assign a management internet protocol address to the first control center 111a by the user during installing the operating system. The management internet protocol address indicates the network location of the first control center 111a so that all the second appliances 13 can identify the first control center 111a in the management LAN 15 according to the management internet protocol address.

In the first example, step S25 may further comprises steps S251, S253, S255 and S257. Step S251 is executed to create a virtual switch 113 connected with the management network port 115 upon installing the operating system. The virtual switch 113 is configured to make connections among the first control center 111a, the management network port 115 and the node daemon 117 of the first appliance 11. Through the virtual switch 113 and the management network port 115, the first control center 111a and the node daemon 117 of the first appliance 11 can be connected with all the node daemons 137 of the second appliances 13 in the management LAN 15. In addition, the first control center 111a can control the node daemon 117 of the first appliance 11 through the virtual switch 113.

Step S253 is executed to combine a configuration of the management internet protocol address into the image file upon installing the operating system; step S255 is executed to connect a virtual network card (not shown) of the first control center 111a with the virtual switch 113 upon installing the operating system; and step S257 is executed to activate the first control center 111a to control the cloud-based system 1 (including the first appliance 11 and all the second appliances 13) through the virtual switch 113, the management network port 115 and the management LAN 15 upon installing the operating system.

By combining the configuration of the management internet protocol address into the image file, the first control center 111a can obtain connection configuration which is necessary for the connection between it and the management LAN 15. Next, upon connecting the virtual network card of the first control center 111a with the virtual switch 113, the first control center 111a, the node daemon 117 of the first appliance 11, and all the node daemons 137 of the second appliances 13 are connected together. Finally, a user can login to the first control center 111a through the management LAN 15 and activate the first control center 111a to control the cloud-based system 1 (including the first appliance 11 and all the second appliances 13) through the virtual switch 113, the management network port 115 and the management LAN 15.

As shown in FIG. 3A, a cloud-based system 3 comprising a plurality of appliances is presented. The appliances may comprise a first appliance 11 and at least one second appliance 13. However, the cloud-based system 3 may merely comprise the first appliance 11, and the control center deployment method of the present invention can still be implemented. The first appliance 11 comprises a node daemon 117 providing various cloud-based services, while each second appliance 13 comprises a node daemon 137 providing various cloud-based services and a management network port 135 connecting with a management LAN 15. In the second example, the control center deployment method is applied to the first appliance 11 in a case where the operating system is installed through a network installation method.

The network installation method means that the operating system is installed on networks. Specifically, a deployment server 30 may be connected with the management LAN 15 to install the operating system and store the image file into the first appliance 11. The method in which the operating system is installed through the deployment server 30 can be readily appreciated by persons skilled in the art, and thus it will not further be described herein.

As shown in FIG. 3B, the control center deployment method is applied to the first appliance 11 to execute steps S21, S232, S234, S252, S254, S256 and S258. As mentioned before, Step S21 is executed to store an image file corresponding to a virtual machine 111 combined with a first control center 111a and installing an operating system simultaneously. The operating system may be referred to as a hypervisor, which might be VMware vSphere, Microsoft Hyper-V, Citrix XenServer, or the like. The node daemon 117 may be created according to the operating system. The image file is configured to deploy the first control center 111a into the virtual machine 111 to create a virtual control center in the first appliance 11.

In the second example, step S23 may further comprises steps S232 and S234. Step S232 is executed to define a management network port 115 connected with the management LAN 15 for the first control center 111a by the deployment server 30 during installing the operating system. The deployment server 30 can choose the network port which is used for installing the operating system to be the management network port 115 so that the first appliance 11 and all the second appliances 13 can be connected in the management LAN 15.

Step S234 is executed to assign a management internet protocol address to the first control center 111a by a user during installing the operating system. The management internet protocol address indicates the network location of the first control center 111a so that all the second appliances 13 can identify the first control center 111a in the management LAN 15 according to the management internet protocol address.

In the second example, step S25 may further comprises steps S252, S254, S256 and S258. Step S252 is executed to create a virtual switch 113 connected with the management network port 115 upon installing the operating system. The virtual switch 113 is configured to make connections among the first control center 111a, the management network port 115 and the node daemon 117 of the first appliance 11. Through the virtual switch 113 and the management network port 115, the first control center 111a and the node daemon 117 of the first appliance 11 can be connected with all the node daemons 137 of the second appliances 13 in the management LAN 15. In addition, the first control center 111a can control the node daemon 117 of the first appliance 11 through the virtual switch 113.

Step S254 is executed to create a virtual network card for the first control center 111a and assign a media access control address (not shown) to the virtual network card upon installing the operating system; step S256 is executed to connect the virtual network card of the first control center 111a with the virtual switch 113 upon installing the operating system; and step S258 is executed to activate the first control center 111a to control the cloud-based system 3 (including the first appliance 11 and all the second appliances 13) through the virtual switch 113, the management network port 115 and the management LAN 15 upon installing the operating system.

By creating the virtual network card for the first control center 111a and assign the media access control address (not shown) to the virtual network card, the first control center 111a can be connected with the management LAN 15 through the virtual switch 113. Next, upon connecting the virtual network card of the first control center 111a with the virtual switch 113, the first control center 111a, the node daemon 117 of the first appliance 11, and all the node daemons 137 of the second appliances 13 are connected together. Finally, a user can login to the first control center 111a through the management LAN 15 and activate the first control center 111a to control the cloud-based system 3 (including the first appliance 11 and all the second appliances 13) through the virtual switch 113, the management network port 115 and the management LAN 15.

According to the above descriptions, the present invention provides a control center deployment method for a cloud-based system. Unlike conventional cloud-based systems, the control center can be deployed into a virtual machine created in one of the appliances of the could-based system and directly controls all the appliances of the could-based system without an additional dedicated appliance. Consequently, the present invention provides a more beneficial control center deployment method in conventional cloud-based systems.

The above disclosure is related to the detailed technical contents and inventive features thereof. Persons skilled in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An control center deployment method for a cloud-based system, the cloud-based system comprising a first appliance, the control center deployment method being applied to the first appliance and comprising:
(a) storing an image file corresponding to a virtual machine combined with a first control center and installing an operating system simultaneously;
(b) defining a management network port connected with a management local area network (LAN) for the first control center during installing the operating system; and
(c) creating a virtual switch to connect the first control center with the management network port upon installing the operating system so that the first control center controls the cloud-based system through the virtual switch and the management LAN.

2. The control center deployment method as claimed in claim 1, wherein the operating system is installed through a non-network installation method.

3. The control center deployment method as claimed in claim 2, wherein step (b) further comprises:
(b11) defining the management network port by a user during installing the operating system; and
(b12) assigning a management internet protocol address to the first control center by the user during installing the operating system.

4. The control center deployment method as claimed in claim 3, wherein step (c) further comprises:
(c11) creating a virtual switch connected with the management network port upon installing the operating system;
(c12) combining a configuration of the management internet protocol address into the image file upon installing the operating system;
(c13) connecting a virtual network card of the first control center with the virtual switch upon installing the operating system; and
(c14) activating the first control center to control the cloud-based system through the virtual switch, the management network port and the management LAN upon installing the operating system.

5. The control center deployment method as claimed in claim 1, wherein the operating system is installed through a network installation method.

6. The control center deployment method as claimed in claim 5, wherein step (b) further comprises:
(b21) defining the management network port by a deployment server connected with the management LAN during installing the operating system; and
(b22) assigning a management internet protocol address to the control center by a user during installing the operating system.

7. The control center deployment method as claimed in claim 6, wherein step (c) further comprises:
(c21) creating a virtual switch connected with the management network port upon installing the operating system;
(c22) creating a virtual network card for the first control center and assign a media access control address to the virtual network card upon installing the operating system;
(c23) connecting the virtual network card of the first control center with the virtual switch upon installing the operating system; and
(c24) activating the first control center to control the cloud-based system through the virtual switch, the management network port and the management LAN upon installing the operating system.

8. The control center deployment method as claimed in claim 1, wherein the cloud-based system further comprises at least one second appliance, the at least one second appliance and the first appliance are connected via the management local area network LAN.

9. The control center deployment method as claimed in claim 8, wherein one second control center has been deployed in the at least one second appliance, and the control center deployment method further comprises the following step:
(e) grouping the first control center with the second control center so that the firs control center and the second control center jointly control the cloud-based system.
